(19) United States
(12) Patent Application Publication
(10) Pub. No.: US 2023/0365840 A1
(43) Pub. Date: Nov. 16, 2023

(54) HIGH TEMPERATURE AND HIGH HUMIDITY STABLE OPTICALLY CLEAR ADHESIVE

(71) Applicant: 3M INNOVATIVE PROPERTIES COMPANY, St. Paul, MN (US)

(72) Inventors: Encai Hao, Woodbury, MN (US); Kristy A. Gillette, Spring Valley, WI (US)

(21) Appl. No.: 18/196,810

(22) Filed: May 12, 2023

Related U.S. Application Data
(60) Provisional application No. 63/342,199, filed on May 16, 2022.

(51) Int. Cl. C09J 7/38

(52) U.S. Cl. CPC C09J 7/385; C09J 2301/16; C09J 2301/414; C09J 2301/416; C09J 2433/00

(57) ABSTRACT

High temperature and high humidity stable optically clear adhesives include a curable (meth)acrylate copolymer having a weight average molecular weight in a range of 100,000 to 400,000 Da, an optional photoinitiator, and a co-curable additive mixture. The additive mixture has at least one epoxy (meth)acrylate oligomer, at least one amine-functional (meth)acrylate, and at least one urethane (meth)acrylate oligomer. The cured adhesive composition has a shear storage modulus (G′) greater than 90 kiloPascals (kPa) when measured at 70° C. and at a frequency of 1 radian/second, and a Tan Delta of 0.2 or less at 70° C., where Tan Delta is the calculated ratio (G″/G′) of the measured shear storage modulus (G′) and shear loss modulus (G″).

### SUMMARY

Disclosed herein are high temperature and high humidity stable optically clear adhesives (OCA) and articles prepared from them. In some embodiments, the curable adhesive composition comprises a curable (meth)acrylate copolymer having a weight average molecular weight in a range of 100,000 to 400,000 Da, an optional photoinitiator, and a co-curable additive mixture. The co-curable additive mixture comprises at least one epoxy (meth)acrylate oligomer, at least one amine-functional (meth)acrylate, and at least one urethane (meth)acrylate oligomer. The cured adhesive composition has a shear storage modulus (G′) of greater than 90 kiloPascals (kPa) when measured at 70° C. and at a frequency of 1 radian/second, and a Tan Delta of 0.2 or less at 70° C. where Tan Delta is the calculated ratio (G″/G′) of the measured shear storage modulus (G′) and shear loss modulus (G″).

Also disclosed are articles. In some embodiments, the articles comprise a substrate with a first major surface and a second major surface, and a cured adhesive composition disposed on at least a portion of the second major surface of the substrate, where the cured adhesive composition is the adhesive composition described above:

### BRIEF DESCRIPTION OF THE DRAWINGS

The present application may be more completely understood in consideration of the following detailed description of various embodiments of the disclosure in connection with the accompanying drawings.

FIG. 1 is a cross sectional view of portion of a display device showing an adhesive layer of this disclosure.

### DETAILED DESCRIPTION

New curable and cured adhesive compositions are needed that can be used, for example, in various electronic display assemblies. The curable and cured adhesive compositions have a variety of needed or desired properties. In particular, curable adhesive compositions are needed that are optically clear, that are in the form of a layer (e.g., film), that have sufficient flow on a substrate to which it is laminated and yet do not flow into small openings present in the substrate.

One use that involves substrate surfaces containing openings, are layers in a variety of optical sensing articles such as collimation films and IR/visible light blocking layers that have been developed, for instance, in organic light emitting diode (OLED) fingerprint sensing (FPS) applications. The optical construction typically includes an air gap between the OLED panel of an optical stack, and the optical stack is affixed to a TFT sensor. As mentioned above, the OCA has to perform adhesively without filling the openings in the substrate surface. The terms “openings” and “pinholes” are used interchangeably herein. The openings can be physical pinholes or optical pinholes, for example. A physical pinhole in an optically opaque material or in a wavelength selective layer, for example, is an opening through the material or layer that allows light from a corresponding microlens to pass through. The pinholes may be formed by laser ablation. Creating openings in a layer using a laser through a microlens array is generally described in US2007/0258149 (Gardner et al.), for example. One such application is described in the co-pending application Attorney Docket Number 84375US002 filed on the same day as the present disclosure.

What was discovered is that many adhesives, especially pressure sensitive adhesive layers, did not have a sufficiently stable performance, particularly under elevated temperature and humidity conditions, and consequently flowed into the pinholes and filled them. Therefore, a new adhesive composition had to be developed that has a sufficiently low or non-flowability at elevated temperature to not fill into pinholes, and yet has sufficient adhesion to adhere to optical substrates. The adhesives are similar to those described in U.S. Pat. No. 10,941,321. It was found that these adhesives were not able to prevent flow of the adhesive into pinholes. Therefore, the adhesive compositions of the current disclosure were developed that have a higher modulus and a lower (<0.2) tan delta at 70° C. than those described in U.S. Pat. No. 10,941,321.

In some embodiments, the curable adhesive composition comprises: a curable (meth)acrylate copolymer having a weight average molecular weight in a range of 100,000 to 400,000 Da; an optional photoinitiator; and a co-curable additive mixture, where the additive mixture comprises: at least one epoxy (meth)acrylate oligomer; at least one amine-functional (meth)acrylate; and at least one urethane (meth)acrylate oligomer.

Also disclosed are articles that contain the curable adhesive composition disposed on a substrate. In some embodiments, the substrate comprises an array of openings, where the curable adhesive composition does not flow into the openings, but rather in some embodiments forms an elevated area above the opening.

As used herein, the term “adhesive composition” can refer herein to an adhesive that contains a curable (meth)acrylate copolymer and/or a cured (meth)acrylate copolymer. In many embodiments, the adhesive composition is a pressure-sensitive adhesive composition.

In many embodiments, the adhesive compositions are pressure-sensitive adhesive compositions. According to the Pressure-Sensitive Tape Council, pressure-sensitive adhesives (PSAs) are defined to possess the following properties: (1) aggressive and permanent tack, (2) adherence with no more than finger pressure, (3) sufficient ability to hold onto an adherend, and (4) sufficient cohesive strength to be removed cleanly from the adherend. Materials that have been found to function well as PSAs include polymers designed and formulated to exhibit the requisite viscoelastic properties resulting in a desired balance of tack, peel adhesion, and shear holding power. PSAs are characterized by being normally tacky at room temperature. Materials that are merely sticky or adhere to a surface do not constitute a PSA; the term PSA encompasses materials with additional viscoelastic properties. PSAs are adhesives that satisfy the Dahlquist criteria for tackiness, which means that the shear storage modulus is typically 3 × 10⁵ Pa (300 kPa) or less when measured at 25° C. and 1 Hertz (6.28 radians/second). PSAs typically exhibit adhesion, cohesion, compliance, and elasticity at room temperature.

As used herein, the term “room temperature” refers to a temperature of about 20° C. to about 25° C. or about 22° C. to about 25° C.

The term “(meth)acryloyl” refers to a group of formula H₂C═CR₁—(CO)— where R₁ is hydrogen or methyl. That is, the (meth)acryloyl group is an acryloyl group (where R₁ is hydrogen) and/or a methacryloyl group (where R₁ is methyl). The (meth)acryloyl group is often a (meth)acryloyloxy group (also known as a (meth)acrylate) of formula H₂C═CR₁—(CO)—O— or a (meth)acryloylamido group of formula H₂C═CR₁—(CO)—NH—.

The term “(meth)acrylate copolymer” refers to a polymeric material formed from two or more monomers (e.g., three or more monomers), wherein the majority (at least 50 weight percent, at least 60 weight percent, at least 70 weight percent, at least 80 weight percent, or at least 90 weight percent) of the monomers used to form the copolymer are (meth)acrylates (e.g., alkyl (meth)acrylates, aryl (meth)acrylates, aralkyl (meth)acrylates, alkaryl (meth)acrylates, and heteroalkyl (meth) acrylate). The term (meth)acrylates includes methacrylates, acrylates, or both. The term (meth)acrylate copolymer can apply herein to the precursor (meth)acrylate copolymer, and/or a curable (meth)acrylate copolymer, and/or a cured (meth)acrylate copolymer.

As used herein, the term “precursor (meth)acrylate copolymer” refers to a (meth)acrylate copolymer that does not contain the third monomeric units of Formula (III) but that can be reacted with an unsaturated reagent compound to form a curable (meth)acrylate copolymer. That is, the precursor (meth)acrylate copolymer can be converted to a curable (meth)acrylate copolymer having a pendant (meth)acryloyl group, which is the second type of third monomeric unit of Formula (III).

As used herein, the term “curable (meth)acrylate copolymer” refers to a (meth)acrylate copolymer that has third monomeric units of Formula (III) in addition to the first monomeric units of Formula (I) and the second monomeric units of Formula (II). The third monomeric units of Formula (III) can be of the first type (having an aromatic ketone group), of the second type (having a pendant (meth)acryloyl group), or both. The third monomeric units can undergo reaction when exposed to ultraviolet radiation (or to ultraviolet or visible light radiation in the presence of a photoinitiator). When the third monomeric units react to form a cured (meth)acrylate copolymer, covalent bonds are formed between different polymeric chains or within the same polymeric chain. This reaction typically increases the weight average molecular weight of the (meth)acrylate copolymer.

As used herein, the term “cured (meth)acrylate copolymer” refers to a (meth)acrylate copolymer resulting from the exposure of the curable (meth)acrylate copolymer to ultraviolet radiation (or to ultraviolet or visible light radiation in the presence a photoinitiator). In some embodiments, the material is considered cured when at least 50 weight percent (e.g., at least 60 weight percent, at least 70 weight percent, at least 80 weight percent, at least 90 weight percent, or at least 95 weight percent) of groups of Formula (III) have reacted to form a crosslinked site.

In many embodiments, particularly when the adhesive composition is used in an electronic display assembly, optical clarity of both the (meth)acrylate copolymer and the adhesive composition are desirable. As used herein, “optically clear” or “optical clarity” means that a material (in a 50 micrometer thick layer) has an optical transmission value of at least 85 percent, preferably at least 90 percent. The term “optical transmission value” refers to the percentage of light that is not reflected back toward the source as a percentage of the total incident light in the visible region of the electromagnetic spectrum (i.e., the optical transmission value is equal to [(light intensity emitted/light intensity source) × 100] at a wavelength of 400 nanometers (nm) to 700 nm). These optically clear materials also have (as measured in a 50 micrometer thick layer) a haze value that is less than 2 percent and a close to color neutral on the CIE Lab color scale. Close to color neutral means that any of the a* or b* values are less than 0.5.

The terms “Tg” and “glass transition temperature” are used interchangeably. The glass transition temperature can be measured using Dynamic Mechanical Analysis at room tempaerature a frequency of 1 radian/second.

The term “alkyl” refers to a monovalent group that is a radical of an alkane, which is a saturated hydrocarbon. The alkyl can be linear, branched, cyclic, or combinations thereof and typically has 1 to 20 carbon atoms. In some embodiments, the alkyl group contains 1 to 18, 1 to 12, 1 to 10, 1 to 8, 1 to 6, or 1 to 4 carbon atoms. Examples of alkyl groups include, but are not limited to, methyl, ethyl, n-propyl, isopropyl, n-butyl, isobutyl, tert-butyl, n-pentyl, n-hexyl, cyclohexyl, n-heptyl, n-octyl, and ethylhexyl.

The term “aryl” refers to a monovalent group that is aromatic and carbocyclic. The aryl can have one to five rings that are connected to or fused to the aromatic ring. The other ring structures can be aromatic, non-aromatic, or combinations thereof. Examples of aryl groups include, but are not limited to, phenyl, biphenyl, terphenyl, anthryl, naphthyl, acenaphthyl, anthraquinonyl, phenanthryl, anthracenyl, pyrenyl, perylenyl, and fluorenyl.

The term “alkylene” refers to a divalent group that is a radical of an alkane. The alkylene can be straight-chained, branched, cyclic, or combinations thereof. The alkylene often has 1 to 20 carbon atoms. In some embodiments, the alkylene contains 1 to 18, 1 to 12, 1 to 10, 1 to 8, 1 to 6, or 1 to 4 carbon atoms. The radical centers of the alkylene can be on the same carbon atom (i.e., an alkylidene) or on different carbon atoms.

The term “arylene” refers to a divalent group that is carbocyclic and aromatic. The group has one to five rings that are connected, fused, or combinations thereof. The other rings can be aromatic, non-aromatic, or combinations thereof. In some embodiments, the arylene group has up to 5 rings, up to 4 rings, up to 3 rings, up to 2 rings, or one aromatic ring. For example, the arylene group can be phenylene.

The term “heteroalkylene” refers to a divalent group that includes at least two alkylene groups connected by a thio, oxy, or —NR— where R is alkyl. The heteroalkylene can be linear, branched, cyclic, substituted with alkyl groups, or combinations thereof. Some heteroalkylenes are poloxyyalkylenes where the heteroatom is oxygen such as for example, —CH₂CH₂(OCH₂CH₂)ₙOCH₂CH₂—.

Disclosed herein are curable adhesive compositions and cured adhesive compositions derived from them. The curable adhesive composition comprises a curable (meth)acrylate copolymer having a weight average molecular weight in a range of 100,000 to 400,000 Da, an optional photoinitiator; and a co-curable additive mixture. The co-curable additive mixture comprises at least one epoxy (meth)acrylate oligomer, at least one amine-functional (meth)acrylate, and at least one urethane (meth)acrylate oligomer. Each of these components is described in detail below.

The curable adhesive composition typically comprises 80-95% by weight of the curable (meth)acrylate copolymer and 5-20 % by weight the co-curable additive mixture, wherein the % by weight is based upon the total dry weight of the curable components.

To prepare the cured adhesive compositions of this disclosure, the curable (meth)acrylate copolymer is mixed with the co-curable additive mixture and the resultant curable composition is cured. This cured adhesive composition is a modification of the adhesive compositions taught in U.S. Pat. No. 10,941,321 and has a higher modulus than the previously disclosed adhesive compositions. This increased modulus provides improvements in a range of properties as is disclosed below.

The curable adhesive compositions comprise a curable (meth)acrylate copolymer. The curable (meth)acrylate copolymer is prepared from monomers described below, and includes first monomeric units, second monomeric units, third monomeric units and optional fourth and/or fifth monomeric units. The curable (meth)acrylate copolymer within the curable adhesive composition can be cured by exposure to ultraviolet radiation (or in some embodiments, by exposure to ultraviolet or visible light radiation in the presence of a photoinitiator). The resulting adhesive, which contains a cured (meth)acrylate copolymer that has co-cured the with additive mixture, can be referred to as a cured adhesive composition. In many embodiments, both the curable and cured adhesive compositions are pressure-sensitive adhesive compositions.

The curable (meth)acrylate copolymer includes at least three different types of monomeric units: first monomeric units of Formula (I), second monomeric units of Formula (II), and third monomeric units of Formula (III). In some embodiments, the curable (meth)acrylate copolymer includes optional fourth monomeric units of Formula (IV) and may include optional firth monomeric units. Depending on the selection of the third monomeric unit, which includes the group responsible for curing the (meth)acrylate copolymer, the curable (meth)acrylate copolymer can be formed directly from a polymerizable composition containing the corresponding first monomer, second monomer, third monomer, and other optional monomers. In some embodiments, particularly for curable (meth)acrylate copolymers having a pendant (meth)acryloyl group, a precursor (meth)acrylate copolymer is initially prepared and then further reacted with an unsaturated reagent compound to form the third monomeric unit (having a pendant (meth)acryloyl group) and the resulting curable (meth)acrylate copolymer.

Stated differently, some curable (meth)acrylate copolymers are formed from precursor (meth)acrylate copolymers while other curable (meth)acrylate copolymers are formed directly from its constituent monomers. The precursor (meth)acrylate copolymer does not have a third monomeric unit of Formula (III) but has a group in a fourth monomeric unit of Formula (IV) that can be further reacted to form the second type of third monomeric unit of Formula (III) having a (meth)acryloyl group. The precursor (meth)acrylate includes the first monomeric units of Formula (I) and the second monomeric units of Formula (II). The curable (meth)acrylate copolymer formed from the precursor (meth)acrylate copolymer has a third monomeric unit of Formula (III) with a pendant (meth)acryloyl group. The cured (meth)acrylate copolymer is formed by exposing the curable (meth)acrylate copolymer to ultraviolet radiation or by exposing the curable (meth)acrylate copolymer to ultraviolet or visible light radiation in the presence of a photoinitiator.

Alternatively, a curable (meth)acrylate copolymer can have a first type of third monomeric units of Formula (III) (with a aromatic ketone group) plus a group in a fourth monomeric unit of Formula (IV) that can be further reacted to form the second type of third monomeric unit of Formula (III) (with a pendant (meth)acryloyl group). Such a curable (meth)acrylate copolymer has both the first type of monomeric unit of Formula (III) and the second type of monomeric unit of Formula (III).

The curable (meth)acrylate copolymer includes a first monomeric unit of Formula (I) in an amount in a range of 50 to 94 weight percent based on a total weight of monomeric units in the curable (meth)acrylate copolymer.

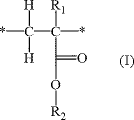

In Formula (I), R₁ is hydrogen or methyl and R₂ is an alkyl, heteroalkyl, aryl, aralkyl, or alkaryl group. Stated differently, the first monomeric unit is derived from an alkyl (meth)acrylate, heteroalkyl (meth)acrylate, aryl (meth)acrylate, aralkyl (meth)acrylate, alkaryl (meth)acrylate, or a mixture thereof (i.e., the (meth)acrylate copolymer can be have multiple first monomeric units with different R₂ groups). Suitable alkyl R₂ groups often have 1 to 32 carbon atoms, 1 to 24 carbon atoms, 1 to 18 carbon atoms, 1 to 16 carbon atoms, 1 to 12 carbon atoms, 1 to 10 carbon atoms, 1 to 8 carbon atoms, 1 to 6 carbon atoms, or 1 to 4 carbon atoms. The alkyl groups can be linear, branched, cyclic, or a combination thereof. Suitable heteroalkyl R² groups often have 1 to 30 carbon atoms or more and 1 to 20 carbon atoms or more, 1 to 20 carbon atoms and 1 to 10 heteroatoms, 1 to 16 carbon atoms and 1 to 8 heteroatoms, 1 to 12 carbon atoms and 1 to 6 heteroatoms, or 1 to 10 carbon atoms and 1 to 5 heteroatoms. The heteroatoms are often oxygen (oxy groups) but can be sulfur (-S- groups) or nitrogen (—NH— groups). Suitable aryl R₂ groups typically are carbocyclic aromatic groups. The aryl group often has 6 to 12 carbon atoms or 6 to 10 carbon atoms. In many embodiments, the aryl is phenyl. Suitable aralkyl groups are of formula -R-Ar where R is an alkylene and Ar is an aryl. The alkylene groups, which are a divalent radical of an alkane, typically have 1 to 10 carbon atoms, 1 to 6 carbon atoms, or 1 to 4 carbon atoms and the aryl group typically has 6 to 12 carbons or 6 to 10 carbons or 6 carbons. In many embodiments, the aryl is phenyl. Suitable alkaryl groups are of formula -Ar-R wherein Ar is an arylene (i.e., divalent radical of a carbocyclic aromatic compound) and R is an alkyl. The arylene typically has 6 to 12 carbon atoms, 6 to 10 carbon atoms, or 6 carbon atoms. In many embodiments, the arylene is phenylene. The alkyl group of the alkaryl group is the same as described above for alkyl groups but often has 1 to 10 carbon atoms, 1 to 6 carbon atoms, or 1 to 4 carbon atoms.

The R₂ group in Formula (I) often is an alkyl. Stated differently, the first monomeric unit is often derived from (i.e., formed from) an alkyl (meth)acrylate. Exemplary alkyl (meth)acrylates often include, but are not limited to, methyl (meth)acrylate, ethyl (meth)acrylate, n-propyl (meth)acrylate, isopropyl (meth)acrylate, n-butyl (meth)acrylate, isobutyl (meth)acrylate, n-pentyl (meth)acrylate, isoamyl (meth)acrylate, 2-methylbutyl (meth)acrylate, n-hexyl (meth)acrylate, cyclohexyl (meth)acrylate, 4-methyl-2-pentyl (meth)acrylate, 2-ethylhexyl (meth)acrylate, 2-methylhexyl (meth)acrylate, n-octyl (meth)acrylate, isooctyl (meth)acrylate, 2-octyl (meth)acrylate, n-nonyl (meth)acrylate, isononyl (meth)acrylate, isobornyl (meth)acrylate), adamantyl (meth)acrylate, n-decyl (meth)acrylate, isodecyl (meth)acrylate, 2-propylheptyl (meth)acrylate, isotridecyl (meth)acrylate, isostearyl (meth)acrylate, octadecyl (meth)acrylate, 2-octyldecyl (meth)acrylate, dodecyl (meth)acrylate, lauryl (meth)acrylate, and heptadecanyl (meth)acrylate. Some other exemplary branched alkyl (meth)acrylates are (meth)acrylic acid esters of Guerbet alcohols having 12 to 32 carbon atoms as described in PCT Patent Application Publication WO 2011/119363 (Clapper et al.). In some embodiments, the alkyl (meth)acrylate is chosen that has an alkyl group with no greater than 8 carbon atoms. These alkyl (meth)acrylate often have a higher solubility parameter compared to those having an alkyl group with greater than 8 carbon atoms. This can increase the compatibility of this monomer with the (meth)acrylamide used to form the second monomeric units.

Group R₂ can be a heteroalkyl, aryl, aralkyl, or alkaryl group. Examples of monomers with a heteroalkyl group include, but are not limited to, ethoxyethoxyethyl (meth)acrylate, polyethylene glycol (meth)acrylate, and polypropylene glycol (meth)acrylate. Examples of such monomers include, but are not limited to, 2-phenylethyl acrylate, 3-phenylethyl acrylate, and 2-biphenylethyl acrylate.

The first monomeric unit is often selected to control the final glass transition temperature (Tg) and shear storage modulus (G′) of the (meth)acrylate copolymer and the adhesive. In many embodiments, the alkyl (meth)acrylates are alkyl acrylates. The use of alkyl acrylates rather than alkyl methacrylates often results in (meth)acrylate copolymers having a lower glass transition temperature and lower shear storage modulus (G′). The lower glass transition temperature and lower shear storage modulus (G′) of the (meth)acrylate copolymers may be needed to provide a pressure-sensitive adhesive composition. The final glass transition temperature (Tg) for the (meth)acrylate copolymer is typically equal to at least -20° C., at least -15° C., at least -10° C., at least -5° C., or at least 0° C. and is often no greater than 40° C., no greater than 30° C., no greater than 20° C., or no greater than 10° C. When the Tg exceeds 20° C., the adhesive may need to be heat-activated (i.e. upon heating slightly above the Tg, the material becomes tacky and adheres with no more than finger pressure). Upon cooling the below Tg these heat-activated adhesive will no longer be tacky but have sufficient ability to hold onto an adherend and have sufficient cohesive strength to be cleanly removed from the adherend. The glass transition temperature can be measured using Dynamic Mechanical Analysis at a frequency of 1 radian/second as described in the Examples section below.

The curable (meth)acrylate copolymer contains at least 50 weight percent of the first monomeric unit based on a total weight of the curable (meth)acrylate copolymer. If the amount of the first monomeric unit is lower than at least 50 weight percent, the glass transition temperature of the (meth)acrylate copolymer may not be suitable for a pressure-sensitive adhesive. For example, the (meth)acrylate copolymer often contains at least 55 weight percent, at least 60 weight percent, at least 65 weight percent, at least 70 weight percent, or at least 75 weight percent of the first monomeric unit. The amount of the first monomeric unit can be up to 94 weight percent. If the amount of the first monomeric unit is greater than 94 weight percent, there may be insufficient amounts of the second monomeric unit and the third monomeric unit in the curable (meth)acrylate copolymer. For example, the amount can be up to 90 weight percent, up to 85 weight percent, or up to 80 weight percent. In some embodiments, the amount of the first monomeric unit is in a range of 50 to 94 weight percent, 60 to 94 weight percent, 70 to 94 weight percent, 80 to 94 weight percent, 60 to 90 weight percent, 70 to 90 weight percent, or 80 to 90 weight percent. The amounts are based on the total weight of the (meth)acrylate copolymer.

The curable (meth)acrylate copolymer further includes a second monomeric unit of Formula (II) in an amount in a range of 6 to 10 weight percent based on the total weight of monomeric units in the curable (meth)acrylate copolymer.

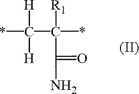

Group R₁ is hydrogen or methyl. Stated differently, the second monomeric unit is derived from (meth)acrylamide, which refers to acrylamide and/or methacrylamide.

The second monomeric unit advantageously provides hydrogen bonding within the curable (meth)acrylate copolymer. This hydrogen bonding tends to enhance the dimensional stability of die-cut films of the adhesive composition prior to curing. Stated differently, dimensional stability can be provided even though no covalent crosslinks have been formed in the curable (meth)acrylate copolymer (i.e. covalent crosslinks form from the third monomeric unit of the curable (meth)acrylate when exposed to ultraviolet radiation or when exposed to ultraviolet or visible light radiation in the presence of a photoinitiator). The second monomeric unit also can enhance adhesion of the cured adhesive composition to substrates and/or enhance the cohesive strength of both the curable and cured adhesive compositions.

The (meth)acrylate copolymer typically contains at least 6 weight percent of the second monomeric unit. This amount is often needed to provide the desired hydrogen bonding within the curable (meth)acrylate copolymer. In some examples, the (meth)acrylate copolymer contains at least 6.5 weight percent or at least 7 weight percent of the second monomeric unit. The amount of the second monomeric unit can be up to 10 weight percent. If greater than 10 weight percent of the second monomeric unit is included in the (meth)acrylate copolymer, the glass transition temperature may be too high to function as a pressure-sensitive adhesive. Additionally, there may be miscibility issues with the other monomers included in the polymerizable composition used to form the (meth)acrylate copolymer. In some examples, the (meth)acrylate copolymer contains up to 9.5 weight percent, up to 9 weight percent, up to 8.5 weight percent, or up to 8 weight percent of the second monomeric unit. The amount of the second monomeric often is in a range of 6 to 10 weight percent, 6.5 to 10 weight percent, 6 to 9 weight percent, or 6 to 8 weight percent based on a total weight of the (meth)acrylate copolymer.

The curable (meth)acrylate copolymer still further comprises a third monomeric unit of Formula (III) in an amount in a range of 0.05 to 5 weight percent based on the total weight of monomeric units of the curable (meth)acrylate copolymer.

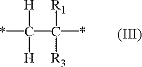

In Formula (III), group R₁ is the same as defined above and group R₃ comprises 1) an aromatic ketone group that causes hydrogen abstraction from a polymeric chain when exposed to ultraviolet radiation or 2) a (meth)acryloyl group (i.e., pendant (meth)acryloyl group) that undergoes free radical polymerization when exposed to ultraviolet or visible light radiation in the presence of a photoinitator. The hydrogen abstraction type aromatic ketone groups typically require exposure to ultraviolet radiation to trigger a reaction. The pendant (meth)acrylate group can react upon exposure to either ultraviolet or visible light radiation based on the absorbance of the photoinitiator in the ultraviolet and visible regions of the electromagnetic spectra.

In the first type of the third monomeric unit of Formula (III), the R₃ group comprises an aromatic ketone group. When exposed to ultraviolet radiation, the aromatic ketone group can abstract a hydrogen atom from another polymeric chain or from another portion of the polymeric chain. This abstraction results in the formation of radicals that can subsequently combine to form crosslinks between polymeric chains or within the same polymeric chain. In many embodiments, the aromatic ketone group is an aromatic ketone group such as, for example, a derivative of benzophenone, acetophenone, or anthroquinone. Monomers that can result in this type of third monomeric unit of Formula (III) include 4-(meth)acryloyloxybenzophenone, 4-(meth)acryloyloxyethoxybenzophenone, 4-(meth)acryloyloxy-4′-methoxybenzophenone, 4-(meth)acryloyloxyethoxy-4′-methoxybenzophenone, 4-(meth)acryloyloxy-4′-bromobenzophenone, 4-acryloyloxyethoxy-4′-bromobenzophenone, and the like.

In the second type of the third monomeric unit of Formula (III), the R₃ group comprises a (meth)acryloyl group. That is, R₃ is a group that can undergo free-radical reaction in the presence of ultraviolet or visible light radiation and a photoinitiator. The curable (meth)acrylate copolymer is typically not prepared directly with this type of third monomeric unit present. Rather, a precursor (meth)acrylate copolymer is initially prepared and then further reacted with an unsaturated reagent compound to introduce the pendant (meth)acryloyl group. Typically, the introduction of the pendant (meth)acryloyl group involves (1) the reaction between a nucleophilic group on the precursor (meth)acrylate copolymer and an electrophilic group on the unsaturated reagent compound (i.e., the unsaturated reagent compound includes both an electrophilic group and a (meth)acryloyl group) or (2) the reaction between electrophilic groups on the precursor (meth)acrylate copolymer and a nucleophilic group on the unsaturated reagent compound (i.e., the unsaturated reagent compound includes both a nucleophilic group and a (meth)acryloyl group). These reactions between the nucleophilic group and electrophilic group typically are ring opening, addition, or condensation reactions.

In some embodiments of this second type, the precursor (meth)acrylate copolymer has hydroxy, carboxylic acid (—COOH), or anhydride (—O—(CO)—O—) groups. If the precursor (meth)acrylate copolymer has hydroxy groups, the unsaturated reagent compound often has a carboxylic acid (—COOH), isocyanato (—NCO), epoxy (i.e., oxiranyl), or anhydride group in addition to a (meth)acryloyl group. If the precursor (meth)acrylate copolymer has carboxylic acid groups, the unsaturated reagent compound often has a hydroxy, amino, epoxy, isocyanato, aziridinyl, azetidinyl, or oxazolinyl group in addition to a (meth)acryloyl group. If the precursor (meth)acrylate copolymer has anhydride groups, the unsaturated reagent compound often has a hydroxy or amine group in addition to a (meth)acryloyl group.

In some examples, the precursor (meth)acrylate copolymer has carboxylic acid groups and the unsaturated reagent compound has an epoxy group. Example unsaturated reagent compounds include, for example, glycidyl (meth)acrylate and 4-hydroxybutyl acrylate glycidyl ether. In other examples, the precursor (meth)acrylate copolymer has anhydride groups and it is reacted with an unsaturated reagent compound that is a hydroxy-substituted alkyl (meth)acrylate such as 2-hydroxyethyl (meth)acrylate, 3-hydroxypropyl (meth)acrylate, or the like. In yet other examples of this second type, the precursor (meth)acrylate copolymer has hydroxy groups and the unsaturated reagent compound has an isocyanato group and a (meth)acryloyl group. Such unsaturated reagent compounds include, but are not limited to, isocyanatoalkyl (meth)acrylate such as isocyanatoethyl (meth)acrylate. The use of a precursor (meth)acrylate copolymer having hydroxy groups may be preferable in applications where the adhesive is used in articles having metal-containing components. Hydroxy groups are less problematic in terms of corrosion than acidic groups or anhydride groups.

The second type of R₃ group can be of formula CH₂═CHR₁—(CO)—Q—L— where L is a linking group and Q is oxy (—O—) or —NH—. The group L includes an alkylene, arylene, or combination thereof and can optionally further include —O—, —O—(CO)—, —NH—(CO)—, —NH—, or a combination thereof depending on the particular precursor (meth)acrylate copolymer and the particular unsaturated reagent compound that is reacted to form the (meth)acryloyl-containing R₃ group. In some particular examples, the second type of R₃ group is H₂C═CHR₁—(CO)—OR₆—NH—(CO)—O—R₅—O—(CO)— formed by the reaction of a pendant hydroxy-containing group of formula —(CO)—O—R₅—OH on the precursor (meth)acrylate with a unsaturated reagent compound that is a isocyanatoalkyl (meth)acrylate of formula H₂C═CHR₁—(CO)—O—R₆—NCO. Groups R₅ and R₆ are each independently an alkylene group such as an alkylene having 1 to 10 carbon atoms, 1 to 6 carbon atoms, or 1 to 4 carbon atoms. R₁ is methyl or hydrogen.

The third monomeric unit is typically present in an amount in a range of 0.05 to 5 weight percent based on a total weight of the (meth)acrylate copolymer. If less than 0.05 weight percent is used, the concentration may be too low to ensure that adequate curing occurs. For example, the concentration can be at least 0.1 weight percent, at least 0.2 weight percent, at least 0.3 weight percent, or at least 0.4 weight percent. An amount over 5 weight percent, however, may result in decreased adhesive performance for an adhesive containing the cured (meth)acrylate copolymer, and/or increased stress buildup in the articles containing the cured (meth)acrylate copolymer, and/or delamination of the adhesive from the substrates within the articles containing the cured (meth)acrylate copolymer. Also, if the third monomeric units are of the first type containing an aromatic ketone group, yellowing can occur in the adhesive layer when the amount exceeds 5 weight percent or even lower. For example, the concentration can be up to 4 weight percent, up to 3 weight percent, up to 2 weight percent, up to 1.5 weight percent, up to 1 weight percent, up to 0.8 weight percent, or up to 0.6 weight percent. In some embodiments, the amount of the third monomeric unit is in a range of 0.1 to 5 weight percent, 0.1 to 4 weight percent, 0.1 to 3 weight percent, 0.1 to 2 weight percent, 0.2 to 2 weight percent, 0.2 to 1.5 weight percent, 0.2 to 1 weight percent, 0.3 to 5 weight percent, 0.3 to 2 weight percent, 0.3 to 1 weight percent, 0.4 to 2 weight percent, or 0.4 to 1 weight percent. If high optical transmission is desired, the amount of the third monomeric unit of the first type is often no greater than 2 weight percent.

The curable (meth)acrylate copolymer optionally can further comprise an optional fourth monomeric unit of Formula (IV) in an amount in a range of 0 to 10 weight percent based on the total weight of the curable (meth)acrylate copolymer.

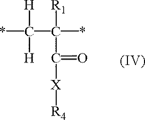

In Formula (IV), group R₁ is the same as defined above, group X is —O— or —NH—, and group R₄ is a hydroxy-substituted alkyl group or hydroxy-substituted heteroalkyl group. In many embodiments, the R₄ group is a hydroxy-substituted alkyl group having 1 to 20 carbon atoms or 1 to 10 carbon atoms and a single hydroxy group. In other embodiments, the R₄ group is a hydroxy-substituted heteroalkyl group having 1 to 20 carbon atoms or 1 to 10 carbon atoms and 1 to 10 heteroatoms, 1 to 6 heteroatoms, or 1 to 4 heteroatoms. The heteroatom is often an oxy (—O—).

Suitable monomeric units of Formula (IV) are typically derived from hydroxy-substituted alkyl (meth)acrylates, hydroxy-substituted alkyl (meth)acrylamides, hydroxy-substituted heteroalkyl (meth)acrylates, and hydroxy-substituted heteroalkyl (meth)acrylamides. Examples of hydroxy-substituted alkyl (meth)acrylates include, but are not limited to, 2-hydroxyethyl (meth)acrylate, 2-hydroxypropyl (meth)acrylate, 3-hydroxypropyl (meth)acrylate, and 4-hydroxybutyl (meth)acrylate. Hydroxy substituted-alkyl (meth)acrylamides include, but are not limited to, 2-hydroxyethyl (meth)acrylamide and 3-hydroxypropyl (meth)acrylamide. Example hydroxy-substituted heteroalkyl (meth)acrylates include hydroxy-terminated alkylene oxide (meth)acrylate, hydroxy-terminated di(alkylene oxide) (meth)acrylate, and hydroxy-terminated poly(alkylene oxide) (meth)acrylate. The alkylene oxide is typically ethylene oxide or propylene oxide. Specific examples of hydroxy-terminated poly(alkylene oxide) (meth)acrylates include various monomers commercially available from Sartomer (Exton, PA, USA) under the trade designation CD570, CD571, and CD572 and from Cognis (Germany) under the trade designation BISOMER (e.g., BISOMER PPA 6).

In some embodiments, a precursor (meth)acrylate copolymer is prepared that contains the fourth monomeric units of Formula (IV). Some or all of these monomeric units are then reacted with an unsaturated reagent compound having an isocyanato group and a (meth)acryloyl group to form the curable (meth)acrylate copolymer. That is, the resulting curable (meth)acrylate copolymer has pendant (meth)acryloyl groups.

The presence of the fourth monomeric unit is not desirable in some applications. For example, for use in electronic displays, minimizing the use of hydroxy-containing monomeric units may be desirable. (Meth)acrylate copolymers with low or no optional fourth monomeric unit may advantageously have a dielectric constant that is less dependent on the relative humidity. That is, more hydrophobic (meth)acrylate copolymers are less likely to absorb water so the dielectric constant is less dependent on the relative humidity. Although it may not be desirable to have hydroxy-containing monomers in some applications, the use of the second monomeric units of Formula (II) (i.e., these monomeric units are from (meth)acrylamide) are considered advantageous because they contribute to hydrogen bonding while being non-corrosive.

In some embodiments, the optional fourth monomeric unit is present in an amount up to 10 weight percent based on a total weight of the (meth)acrylate copolymer. The presence of the optional fourth monomeric unit can increase the dielectric constant of the (meth)acrylate copolymer. The amount of the fourth monomeric unit can be up to 9 weight percent, up to 8 weight percent, up to 6 weight percent, or up to 5 weight percent. The optional fourth monomeric unit can be absent or can be present in an amount equal to at least 0.1 weight percent, at least 0.5 weight percent, or at least 1 weight percent. For example, the optional fourth monomer can be present in an amount in a range of 0 to 10 weight percent, 1 to 10 weight percent, 0 to 8 weight percent, 1 to 8 weight percent, 0 to 5 weight percent, or 1 to 5 weight percent.

The amount of the optional fourth monomeric unit is often lower in the curable (meth)acrylate and cured (meth)acrylate than in the precursor (meth)acrylate if the third monomeric unit has a (meth)acryloyl group. That is, part of all of the fourth monomeric unit in the precursor (meth)acrylate copolymer may be used to attach the (meth)acryloyl group by reacting with the unsaturated reagent compound as discussed above.

In addition to the optional fourth monomeric unit of Formula (IV), other optional monomeric units (fifth monomeric units) can be present in the (meth)acrylate copolymer. Other optional monomeric units are typically selected based on compatibility with the other monomeric units in the (meth)acrylate copolymer. These optional monomeric units may also be used to tune the rheological properties of the (meth)acrylate copolymer, such as for adjusting the glass transition temperature or shear storage modulus (G′). These optional monomeric units are also typically selected based on the final use of the curable and/or cured (meth)acrylate copolymer. For example, if the curable and/or cured (meth)acrylate copolymer is used in an electronic display assembly, any optional monomeric units are selected so that an optically clear adhesive can be prepared. For example, monomeric units with aromatic groups (at least in amounts that would interfere with optical clarity) might be advantageously avoided (e.g., styrene). Exemplary optional fifth monomers include acid-functional monomers such as acrylic acid and methacrylic acid.

The amount of any other optional monomer or combination of optional monomers is typically no greater than 20 weight percent based on a total weight of the curable (meth)acrylate copolymer. That is, the amount of the other optional monomer is no greater than 15 weight percent, no greater than 10 weight percent, or no greater than 5 weight percent and, if present, equal to at least 1 weight percent, at least 2 weight percent, or at least 5 weight percent. The amount can be in a range of 0 to 20 weight percent, 1 to 20 weight percent, 5 to 20 weight percent, 0 to 10 weight percent, 1 to 10 weight percent, 0 to 5 weight percent, or 1 to 5 weight percent.

In addition to the monomers used to form the various monomeric units described above, the polymerizable composition used to prepare the (meth)acrylate copolymer typically includes a free radical initiator to commence polymerization of the monomers. The free radical initiator can be a photoinitator or a thermal initiator. The amount of the free radical initiator is often in a range of 0.05 to 5 weight percent based on a total weight of monomers used.

Suitable thermal initiators include various azo compound such as those commercially available under the trade designation VAZO from E. I. DuPont de Nemours Co. (Wilmington, DE, USA) including VAZO 67, which is 2,2′-azobis(2-methylbutane nitrile), VAZO 64, which is 2,2′-azobis(isobutyronitrile), VAZO 52, which is (2,2′-azobis(2,4-dimethylpentanenitrile), and VAZO 88, which is 1,1′-azobis(cyclohexanecarbonitrile); various peroxides such as benzoyl peroxide, cyclohexane peroxide, lauroyl peroxide, di-tert-amyl peroxide, tert-butyl peroxy benzoate, di-cumyl peroxide, and peroxides commercially available from Atofina Chemical, Inc. (Philadelphia, PA) under the trade designation LUPEROX (e.g., LUPEROX 101, which is 2,5-bis(tert-butylperoxy)-2,5-dimethylhexane, and LUPEROX 130, which is 2,5-dimethyl-2,5-di-(tert-butylperoxy)-3-hexyne); various hydroperoxides such as tert-amyl hydroperoxide and tert-butyl hydroperoxide; and mixtures thereof.

In many embodiments, a photoinitiator is used, particularly when the second type of monomeric unit of Formula (III) is used. Some exemplary photoinitiators are benzoin ethers (e.g., benzoin methyl ether or benzoin isopropyl ether) or substituted benzoin ethers (e.g., anisoin methyl ether). Other exemplary photoinitiators are substituted acetophenones such as 2,2-diethoxyacetophenone or 2,2-dimethoxy-2-phenylacetophenone (commercially available under the trade designation IRGACURE 651 from BASF Corp. (Florham Park, NJ, USA) or under the trade designation ESACURE KB-1 from Sartomer (Exton, PA, USA)). Still other exemplary photoinitiators are substituted alpha-ketols such as 2-methyl-2-hydroxypropiophenone, aromatic sulfonyl chlorides such as 2-naphthalenesulfonyl chloride, and photoactive oximes such as 1-phenyl-1,2-propanedione-2-(O-ethoxycarbonyl)oxime. Other suitable photoinitiators include, for example, 1-hydroxycyclohexyl phenyl ketone (commercially available under the trade designation IRGACURE 184), bis(2,4,6-trimethylbenzoyl)phenylphosphineoxide (commercially available under the trade designation IRGACURE 819), 2,4,6-trimethylbenzoylphenylphosphinic acid ethyl ester (commercially available under the trade designation IRGACURE TPO-L), 1-[4-(2-hydroxyethoxy)phenyl]-2-hydroxy-2-methyl-1-propane-1-one (commercially available under the trade designation IRGACURE 2959), 2-benzyl-2-dimethylamino-1-(4-morpholinophenyl)butanone (commercially available under the trade designation IRGACURE 369), 2-methyl-1-[4-(methylthio)phenyl]-2-morpholinopropan-1-one (commercially available under the trade designation IRGACURE 907), and 2-hydroxy-2-methyl-1-phenyl propan-1-one (commercially available under the trade designation DAROCUR 1173 from Ciba Specialty Chemicals Corp. (Tarrytown, NY, USA).

The polymerizable composition may optionally further contain a chain transfer agent to control the molecular weight of the resultant (meth)acrylate copolymer. Examples of useful chain transfer agents include, but are not limited to, carbon tetrabromide, alcohols (e.g., ethanol and isopropanol), mercaptans or thiols (e.g., lauryl mercaptan, butyl mercaptan, tert-dodecyl mercaptan, ethanethiol, isooctylthioglycolate, 2-ethylhexyl thioglycolate, 2-ethylhexyl mercaptopropionate, ethyleneglycol bisthioglycolate), and mixtures thereof. If used, the polymerizable mixture may include up to 1 weight percent of a chain transfer agent based on a total weight of monomers. The amount can be up to 0.5 weight percent, up to 0.3 weight percent, up to 0.2 weight percent, or up to 0.1 weight percent and is often equal to at least 0.005 weight percent, at least 0.01 weight percent, at least 0.05 weight percent, or at least 0.1 weight percent. For example, the polymerizable composition can contain 0.005 to 0.5 weight percent, 0.01 to 0.5 weight percent, 0.05 to 0.2 weight percent, 0.01 to 0.2 weight percent, or 0.01 to 0.1 weight percent chain transfer agent based on the total weight of monomers.

The polymerizable composition used to form the curable (meth)acrylate copolymer can further include other components such as, for example, antioxidants and/or stabilizers such as hydroquinone monomethyl ether (p-methoxyphenol, MeHQ), BHT (2,6-Di-Tert-Butyl-4-Methylphenol), and those available under the trade designation IRGANOX 1010 (tetrakis(methylene(3,5-di-tert-butyl-4-hydroxyhydrocinnamate))methane) from BASF Corp. (Florham Park, NJ, USA). The antioxidant and/or stabilizer can be used to increase the temperature stability of the resulting (meth)acrylate copolymer. If used, an antioxidant and/or stabilizer is typically used in the range of 0.01 percent by weight (weight percent) to 1.0 weight percent, based on the total weight of monomers in the polymerizable composition.

The polymerization to form the curable (meth)acrylate copolymer can occur in the presence or absence of an organic solvent. If an organic solvent is included in the polymerizable composition, the amount is often selected to provide the desired viscosity to the polymerizable composition and to the polymerized composition. Examples of suitable organic solvents include, but are not limited to, methanol, tetrahydrofuran, ethanol, isopropanol, heptane, acetone, methyl ethyl ketone, methyl acetate, ethyl acetate, toluene, xylene, and ethylene glycol alkyl ether. Those solvents can be used alone or combined as mixtures. In some embodiments, the organic solvent is present in an amount less than 15 weight percent, less than 10 weight percent, less than 8 weight percent, less than 6 weight percent, less than 5 weight percent, or less than 2 weight percent based on the total weight of the polymerizable composition. If used, any organic solvent typically is removed at the completion of the polymerization reaction with the additive mixture or during coating. In many embodiments, the polymerization occurs with little or no organic solvent present. That is the polymerizable composition is free of organic solvent or contains a minimum amount of organic solvent.

Either the curable (meth)acrylate copolymer or the precursor (meth)acrylate copolymer, depending on the type of monomeric unit of Formula (III) that is used, can be prepared by any conventional polymerization method (such as solution polymerization or emulsion polymerization) including thermal bulk polymerization under adiabatic conditions, as is disclosed in U.S. Pat. Nos. 5,637,646 (Ellis) and 5,986,011 (Ellis et al.). Other methods of preparing either type of (meth)acrylate copolymer include the continuous free radical polymerization methods described in U.S. Pat. Nos. 4,619,979 and 4,843,134 (Kotnour et al.) and the polymerization within a polymeric package as described in U.S. Pat. No. 5,804,610 (Hamer et al.).

The curable (meth)acrylate copolymer has a weight average molecular weight (M_{w}) that is in a range of 100,000 to 400,000 Daltons (Da). The adhesive may not have a suitable creep compliance at 25° C. and at 70° C. if the weight average molecular weight is outside of this range. If the molecular weight is lower than 100,000 Da, the amount of the third monomeric unit needed to effectively cure the (meth)acrylate copolymer may be quite high. If the amount of the third monomeric unit is too high, the curing reaction may proceed too rapidly. That is, the (meth)acrylate copolymer may change from having no gel content to having a very high gel content (and thus a highly elastic cured adhesive composition, which may not be desirable in some applications) after exposure to a very low dose of ultraviolet or visible light radiation. The weight average molecular weight is often at least 150,000 Da, at least 200,000 Da, or at least 250,000 Da. If the molecular weight is greater than 400,000 Da, however, the dry curable (meth)acrylate copolymer may have a viscosity that is too high and a stress-relaxation time that is too long to effectively flow and cover various features (e.g., ink-steps) on a substrate. The molecular weight can be up to 350,000 Da or up to 300,000 Da. In some embodiments, the weight average molecular weight is in a range of 100,000 to 350,000 Da, in a range of 100,000 to 300,000 Da, in a range of 150,000 to 400,000 Da, or in a range of 200,000 to 400,000 Da. The weight average molecular weight can be determined by Gel Permeation Chromatography (GPC).

In some particularly suitable curable adhesive compositions, the curable (meth)acrylate copolymer comprises: Formula (I) monomers that are a mixture of alkyl (meth)acrylates with alkyl groups having 8 or fewer carbon atoms; a Formula (II) monomer of (meth)acrylamide; a Formula (III) monomer unit formed by the combination of a hydroxyl-functional (meth)acrylate that is polymerized into the (meth)acrylate matrix and subsequently reacted with an isocyanate-functional (meth)acrylate; and an acid-functional (meth)acrylate.

The curable adhesive composition further comprises a co-curable additive mixture. The additive mixture comprises at least one epoxy (meth)acrylate oligomer, at least one amine-functional (meth)acrylate (different from monomer of Formula II above), and at least one urethane (meth)acrylate oligomer. Each of these components is described below. Typically, the additive mixture is added to the curable (meth)acrylate copolymer described above and the mixture is cured to form the cured adhesive composition. Generally, a photoinitiator, as described above is used to cure the curable (meth)acrylate copolymer and the co-curable additive mixture.

The co-curable additive mixture comprises at least one epoxy (meth)acrylate oligomer. These materials are monofunctional or difunctional containing a (meth)acrylate group and are formed by reacting a mono- or di-functional epoxy with (meth)acrylic acids. Generally, the epoxy (meth)acrylate oligomer is of general Formula V:

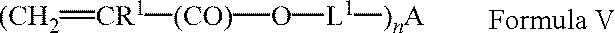

where R¹ is H or methyl; (CO) is a carbonyl group; n is an integer of 1 or 2; L¹ is a divalent linking group comprising a hydroxyl-functional alkylene group; and A is an n-valent group containing alkyl, alkylene, aryl, arylene, aralkyl, and aralkylene groups, and may contain one or more heteroatoms. The group L¹ is a hydroxyl-functional alkylene group where the hydroxyl-functional alkylene group is formed by the reaction of (meth)acrylic acid with an oxirane ring (a three membered ring comprising an oxygen atom linked to two carbon atoms). In many embodiments, n = 2, making the epoxy (meth)acrylate oligomer divalent, being formed from the reaction of a di-functional epoxy with (meth)acrylic acid. Examples of suitable epoxy (meth)acrylate oligomers include those available from Sartomer. One particularly suitable epoxy (meth)acrylate oligomer is available from Sartomer under the trade name CN104, wherein the group A is a bisphenol A-based group.

The co-curable additive mixture further comprises at least one amine-functional (meth)acrylate, where the amine-functional (meth)acrylate is not a monomer of Formula (II) described above. Suitable monomers include, for example, monomeric units derived from various N-alkyl (meth)acrylamides and N,N-dialkyl (meth)acrylamides such as N-methyl (meth)acrylamide, N-ethyl (meth)acrylamide, N,N-dimethyl (meth)acrylamide, and N,N-diethyl (meth)acrylamide, N-isopropyl (meth)acrylamide, and N-octyl (meth)acrylamide. Other monomeric units derived from various N,N-dialkylaminoalkyl (meth)acrylates and N,N-dialkylaminoalkyl (meth)acrylamides can be included such as, for example, N,N-dimethyl aminoethyl (meth)acrylate, N,N-dimethylaminoethyl (meth)acrylamide, N,N-dimethylaminopropyl (meth)acrylate, N,N-dimethylaminopropyl (meth)acrylamide, N,N-diethylaminoethyl (meth)acrylate, N,N-diethylaminoethyl (meth)acrylamide, N,N-diethylaminopropyl (meth)acrylate, and N,N-diethylaminopropyl (meth)acrylamide. Other examples include monomeric units derived from N-vinyl pyrrolidone, N-morpholino (meth)acrylate, diacetone (meth)acrylamide, and N-vinyl caprolactam. Particularly suitable is DMAPMA N,N-dimethylaminopropyl (meth)acrylamide.

The co-curable additive mixture further comprises at least one urethane (meth)acrylate oligomer. These materials are of general Formula VI:

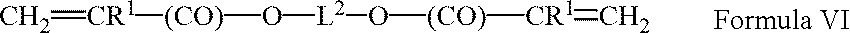

where R¹ is H or methyl; (CO) is a carbonyl group; L² is divalent linking group comprising at least one urethane linkage and further comprise alkylene groups, arylene groups, aralkylene groups, heteroalkylene groups, polyester groups, or a combination thereof. Examples of commercially available polyurethane diacrylates include those from Sartomer under the trade designation CN9018 and CN983. Particularly suitable is CN983 from Sartomer in which the group L² comprises polyester segments. linked by urethane groups.

As mentioned above, the curable adhesive composition typically comprises 80-95% by weight of the curable (meth)acrylate copolymer and 5-20 % by weight the co-curable additive mixture, wherein the % by weight is based upon the total dry weight of the curable components. The curable adhesive composition may also comprise additional additives if desired. These additives may be added to the curable (meth)acrylate copolymer as described above, or they may be added to the overall curable adhesive composition. Examples of suitable additives include tackifiers, plasticizers, antioxidants, UV stabilizers, UV absorbers, pigments, curing agents, polymer additives. These other optional additives can be selected, if desired, so that they do not significantly reduce the optical clarity of the adhesive composition.

The curable adhesive compositions described above are cured to form adhesives that have desirable properties. The cured adhesive is a pressure sensitive adhesive or has pressure sensitive properties. Typically, the curable compositions are prepared by preparing the curable (meth)acrylate copolymer as described above, optionally caring out an additional reaction to form the Formula (III) groups (for example by polymerizing a hydroxyl-functional (meth)acrylate into the (meth)acrylate matrix and then reacting with an isocyanate-functional (meth)acrylate to form the units of Formula (III) as is described above. The curable (meth)acrylate copolymer is combined with an optional photoinitiator and the co-curable additive mixture described above. This curable adhesive composition is generally formed into a layer by disposing the composition onto a substrate (such as a release liner) by coating or other suitable techniques. This layer is typically dried if solvent was used, and dried layer can be cured to form the adhesive layer, or the dried layer (e.g. a film) can be stored or transported for later curing by a customer.

The cured adhesive composition has a variety of desirable properties as described above. Among these properties are optical clarity, a suitable Tg (typically -6° C. or lower), and most importantly a resistance to flowing into pinholes at elevated temperature and humidity. The cured adhesive composition has a shear storage modulus (G′) of at least 90 kiloPascals (kPa) when measured at 70° C. and at a frequency of 1 radian/second. Additionally, the cured adhesive composition has a Tan Delta of 0.2 or less at 70° C. where Tan Delta is the calculated ratio (G″/G′) of the measured shear storage modulus (G′) and shear loss modulus (G″).

Also disclosed herein are articles. In some embodiments, the article comprises a first substrate and a layer of the curable or cured adhesive composition adjacent to the first substrate. The layer of the curable adhesive composition is often in the form of a film. As used herein, the term “adjacent” can be used to refer to two materials, typically in the form of layers, that are in direct contact or that are separated by one or more other materials, such as primer or hard coating layers. Often, adjacent materials are in direct contact.

Various methods can be used to form the article. For example, an adhesive composition containing a curable (meth)acrylate copolymer, an optional photoinitiator, a co-curable additive mixture, and any other optional additives can be coated out of a solvent or from a melt. Such methods are well known to those of skill in the art. If processed out of a coating composition that includes a solvent, a suitable solvent is one that is miscible with the other components of the coating composition. By this, it is meant that the coating composition remains homogeneous in diluted form and during drying such that there is no premature separation of the components out of the solvent. A suitable solvent, if used, is one that can be removed easily from the coated layer. Also, a suitable solvent is one that does not damage the substrate to which the coating composition is applied (for example, it cannot cause crazing of a polymer film). Exemplary solvents include methyl ethyl ketone, methyl isobutyl ketone, 1-methoxy-2-propanol, isopropyl alcohol, toluene, ethyl acetate, butyl acetate, acetone, and the like, and mixtures thereof.

In many embodiments, the article includes a first substrate, a second substrate, and a layer of the curable adhesive composition positioned between the first substrate and the second substrate. Thus, certain articles can be laminates that include an optically clear substrate (e.g., an optical substrate such as an optical film) and an optically clear adhesive layer of the cured or curable adhesive composition adjacent to at least one major surface of the optically clear substrate. The laminates can further include a second substrate permanently or temporarily attached to the adhesive layer and with the adhesive layer being positioned between the optically clear substrate and the second substrate.

In some example laminates, an optically clear adhesive layer (i.e., a cured or curable adhesive composition described herein) is positioned between two substrates and at least one of the substrates is an optical film, a display unit, a touch sensor, or a lens. Optical films intentionally enhance, manipulate, control, maintain, transmit, reflect, refract, absorb, retard, or otherwise alter light that impinges upon a surface of the optical film. Optical films included in the laminates include classes of material that have optical functions, such as polarizers, interference polarizers, reflective polarizers, diffusers, colored optical films, mirrors, louvered optical film, light control films, transparent sheets, brightness enhancement film, anti-glare, and anti-reflective films, and the like. Optical films for the provided laminates can also include retarder plates such as quarter-wave and half-wave phase retardation optical elements. Other optically clear films can include anti-splinter films and electromagnetic interference filters. The films may also be used as substrates for ITO (i.e., indium tin oxide) coating or patterning, such as use those used for the fabrication of touch sensors.

In some embodiments, laminates that include a curable or cured adhesive as describe herein can be optical elements, or can be used to prepare optical elements. As used herein, the term “optical element” refers to an article that has an optical effect or optical application. The optical elements can be used, for example, in electronic displays (e.g., liquid crystal displays (LCDs), organic light emitting displays (OLEDs), architectural applications, transportation applications, projection applications, photonics applications, and graphics applications). Suitable optical elements include, but are not limited to, glazing (e.g., windows and windshields), screens or displays, polarizing beam splitters, cathode ray tubes, ITO-coated touch sensors such as those using glass or clear plastic substrates, and reflectors.

In addition to various optics-related applications and/or electronic display assembly applications, both the curable and cured adhesive compositions can be used in a variety of other applications. For example, an article can be formed by forming a layer (e.g., film) of a curable adhesive composition on a backing or release liner. If a release liner is used, the layer can be transferred to another substrate. The other substrate can be, for example, a component of an electronic display assembly. That is, the layer can be laminated to another substrate. The film is often laminated between a first substrate and a second substrate (i.e., the layer of curable adhesive is positioned between the first substrate and the second substrate).

In some embodiments, the articles comprise a substrate with a first major surface and a second major surface, and a cured adhesive composition disposed on at least a portion of the second major surface of the substrate. The cured adhesive compositions have been described in detail above. As was mentioned above, the disclosed adhesives have a high modulus making them particularly suitable for applications where the substrate surface has openings into which it is undesirable for the adhesive to flow. Thus, when the second major surface of the substrate comprises a plurality of openings, where the openings comprise holes through the substrate or cavities within the substrate, the cured adhesive composition covering the openings does not flow into the openings. In some of these embodiments, the adhesive composition covering the openings provides an elevated feature, where the elevated feature is raised above the plane of the second major surface of the substrate.

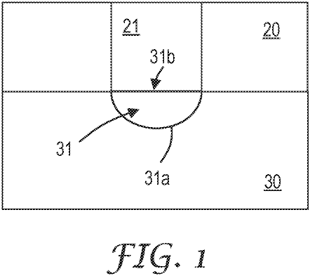

One particularly suitable use for the currently disclosed adhesive compositions is described in FIG. 1. FIG. 1 is a portion of a multilayer display system, for instance, a fingerprint sensing display system for sensing a finger of a user applied to the display system. The display system is described in detail in co-pending application Attorney Docket No. 84375US003 filed on the same day as the current disclosure. The display system includes a light absorbing layer (20). The light absorbing layer (20) may be an optically opaque mask layer defining a plurality of through first openings (21). The first openings (21) can have any suitable shape. In some embodiments, the first openings (21) may include at least one of elliptical pinholes, circular pinholes, rectangular pinholes, square pinholes, triangular pinholes, and irregular pinholes. In some cases, the first openings (21) may include any combinations of these pinhole shapes. The first openings (21) may be formed by laser ablation, for example. Creating openings in a layer using a laser is generally described in US2007/0258149 (Gardner et al.).

The light absorbing layer (20) substantially blocks (e.g., blocks at least 60% of light by absorption, reflection, or a combination thereof) incident light in regions between the first openings (21) for at least one wavelength and for at least one polarization state. In some embodiments, the light absorbing layer (20) includes the first openings (21) in a substantially optically opaque material or includes the first openings (21) in a wavelength selective filter, for example.

As described above, the cured optical adhesive layer (30) is disposed on the second major surface of the light absorbing layer (20). As best seen in FIG. 1, the adhesive layer (30) does not flow into the opening (21) but rather forms an elevated portion over the opening (21). Because of the directionality of the figure, these elevations are shown as recesses in the figure. The recess may be of any desired shape and configuration having a closed bottom (31a) and an opposite open top (31b) open to the first opening (21). The desired optical performance can be obtained by design and selection of the OCA and either filling the first openings (21) with OCA or maintaining air inside the first openings (21). In some aspects, a low modulus OCA was found to fill the first openings (21) while the high modulus adhesive of this disclosure has been found to maintain air within the first openings (21). In some cases, at least 80% of a total volume of each of the recess (31) and the first opening (21) corresponding to the recess (31) may be filled with air. In some cases, at least 85%, or 90%, or 95%, or 96%, or 97%, or 98%, or 99% of a total volume of each of the recess (31) and the first opening (21) corresponding to the recess (31) may be filled with air.

Examples

| | | |
|---|---|---|
| CAS | Name | Supplier |
| 141-32-2 | Butyl acrylate (BA) (N-BUTYL ACRYLATE 10-20 PPM MEHQ) | BASF |
| 97-63-2 | 2-Ethylhexylmethacrylate (2-EHMA) (ETHYL METHACRYLATE 15 PPM MEHQ) | Lucite International Inc |
| 103-11-7 | 2-Ethylhexyl acrylate (2-EHA) | BASF |
| 818-61-1 | Hydroxyethylacryalte (2-HEA) (HYDROXY ETHYL ACRYLATE 97.0% MIN) | KOWA |
| 79-06-1 | Acrylamide (ACM) (ACRYLAMIDE MONOMER) | Mytech Specialty Chemicals |
| 79-10-7 | Acrylic acid (AA) (GLACIAL ACRYLIC ACID 200 PPM MEHQ) | BASF |
| 31775-89-0 (Main comp) 1027326-93-7 (Sub comp) | pentaerythritol tetrakis(3-mercaptobutylate) (KarenzMT PE1) | Showa Denko |
| 4419-11-8 | Vazo 52 (2,2 AZODI 2,4 DIMETHYLVALERONITRILE) | DuPont |
| 141-78-6 | Ethyl Acetate (ETHYL ACETATE 99%) | Honeywell |
| 128-37-0 | BHT (2,6-DI-TERT-BUTYL-4-METHYLPHENOL (B1378)) | Sigma Aldrich |
| 30674-80-7 | 2-Isocyanatoethyl methacrylate (IEM) | Showa Denko |
| VISIOMER® DMAPMA | N-[3-(Dimethylamino)propyl]methacrylamide | Evonik Industries, Essen, Germany |
| CN983 | A difunctional polyester urethane oligomer | Sartomer, Exton, Pennsylvania |
| CN104 | A difunctional epoxy acrylate oligomer | Sartomer, Exton, Pennsylvania |
| 162881-26-7 | OMNIRAD 819 BIS(2,4,6-TRIMETHYLBENZOYL) PHENYLPHOSPHINE OXIDE | IGM |
| Film 1 | An integrated collimation film containing a Microlens array with an integrated pinhole layer, having a pinhole array. | Described in detail in co-pending application Attorney Docket Number 84375US002 |
| RF17N | Silicone coated pet liners | SKC Hass, Korea |
| RF02N | Silicone coated pet liners | SKC Hass, Korea |

### Characterization/Equipment

Launderometer: the polymers were prepared by bottle polymerizations using an SDL Atlas Launderometer, model number M228AA.

Intrinsic Viscosity (IV): IV samples were dissolved in EtOAc at a concentration of 0.25 g/dL. A Lauda PVS Intrinsic Viscometer and a glass Cannon-Fenske Viscometer were used. The water bath temperature was 24 C.

### Test Method 1. Dynamic Mechanical Analysis

Dynamic mechanical analysis (DMA) was accomplished using an DHR3 PARALLEL PLATE RHEOMETER (TA Instruments) to characterize the physical properties of each sample as a function of temperature. For each sample, approximately 0.5 g of material was centered between 8 mm diameter parallel plates of the rheometer and compressed until the edges of the sample were uniform with the edges of the top and bottom plates. The furnace doors that surround the parallel plates and shafts of the rheometer were shut and the temperature was raised to 140° C. and held for 5 minutes. The temperature was then ramped from 120° C. to -20° C. at 3° C./min while the parallel plates were oscillated at a frequency of 1 Hz and a constant % strain of 0.4%. While many physical parameters of the material are recorded during the temperature ramp, storage modulus (G′), loss modulus (G″), and tan delta are of primary importance in the characterization of the homopolymers of this disclosure.

### Testing Method 2: Optical Tests

TD (transmission) test of Film 1 films with OCA were measured using a Haze-Gard Plus from BYK-Gardner USA, Columbia, Md. Prior to testing, the OCA was laminated between Film 1 film and 2-mil (50 micrometer) thick PET (polyehtylene terephthalate) film with hand lamination, then the laminated parts were autoclaved at 50° C. and 5 Kg pressure for 20 min. An Edmund diffuser plate was first placed in front of the transmission pot, then the Film 1 construction Film 1/OCA/PET) was placed outside of diffuser plate toward to the clarity spot side. The transmission data were recorded and reported as Td and are in %.

### Testing Method 3: Scanning Electron Microscopy (SEM) Analysis

The direct evidence of the presence of air pinholes within the laminated structures were tested by cross-section SEM method. Optical laminate samples of Film 1/OCA/PET were embedded and cured in epoxy resin. Each sample was cross sectioned via ultramicrotomy using a Leica UC7. A Thermo Fisher Scientific Scios II dual-beam FIB (focused ion beam) -SEM (scanning electron microscope) was used to examine and image the holes in the ink layer, in addition to the adjacent OCA and polymer layers. Material was ablated away using the gallium ion beam to expose the voids and investigate the hole dimensions.

### 1. Curable (Meth)Acrylate Co-Polymer Polymerization

504 g 2-EHA, 640 g BA, 160 g 2-EHMA, 48 g ACM, 240 g HEA, 8 g AA, 3.52 g PE-1 and 1600 g ethyl acetate were charged into a 5 L Buchi reactor. The solution was heated up to 60° C. and mixed for 30 minutes use 150 rpm agitation. 0.32 g Vazo-52 was dissolved in 10 g ethyl acetate in a 4 oz jar, then added into the reactor. The reactor was purged with N₂ (pressure-release) for several times until the reaction started. The start of the reaction was indicated by the batch temperature increase and jacket temperature decrease. Once the reaction was started, kept the reaction under 5 psi N₂ pressure with 150 rpm agitation speed. The reaction was held at 60° C. for 5 hours. 1.12 g Vazo-52 was dissolved in 25 g of ethyl acetate in a 4 oz jar. It was then transferred into a 50 mL charge bomb. O₂ was removed from charge bomb by purging N₂ for 5 times. After 5 hours of reaction, the pre-dissolved Vazo-52 was charged into reactor. The reaction temperature was then increased to 65° C. and kept at 65° C. for 12 hours.

### 2. IEM Functionalization

Control gas (90/10 N₂/O₂) was purge into 200 g of the polymer solution obtained above. 0.1 g BHT and 0.15 g IEM were added to the polymer solution. The polymer solution was stirred at 75° C. for 4 hours to complete the IEM functionalization (0.15% IEM functionalization). For 0.5% IEM functionalization, increase IEM amount to 0.5 g using the same procedure. The final IEM functionalized polymer solution was adjusted to 46.8%wt solid in ethyl acetate. The IV of final IEM-functionalized base polymer was measure at 0.79.

### 3. High Modulus Adhesive Formulations:

### Comparative Example Formulation 1

In an 8 OZ brown jar, 120 g of IEM functionalized polymer solution with 0.15% IEM, 67 g of MEK, 7.863 g of CN983 (50%wt solid in MEK), 2.25 of CN996 (50%wt solid in MEK), and 2.25 g of Irgacure 819 (10%wt solid in MEK) were mixed together, and mixture was placed on a roller mixer for overnight to form a homogenous coating solution.

### Example Formulation 1

In an 8 OZ brown jar, 120 g of IEM functionalized polymer solution with 0.5% IEM, 67 g of MEK, 7.863 g of CN983 (50%wt solid in MEK), 2.25 of CN104 (50%wt solid in MEK), 1.13 g of DMEAPMA, and 2.25 g of Irgacure 819 (10%wt solid in MEK) were mixed together, and mixture was placed on a roller mixer for overnight to form a homogenous coating solution.

### 4. Preparation of High Modulus OCA Adhesive

First, the adhesive coating solutions (Comparative Example 1 and Example 1) prepared above was pumped using a Zenith pump at a rate of 37 cc/min into an 8-inch-wide slot-type coating die, the slot coating die uniformly distributed a 4 inch wide coating onto a 3mil thick PET liner (RF17N) moving at 10 ft/min.

The moving web was passing a gap dryer with 120° F. and 30 feet long oven setting at 200° F., then the dried adhesive coatings were cured using UV-LED (405) array with 2.25 J/cm2 input light power. For Experiment 1 samples, several different UV input powers were selected to understand the adhesive properties vs curing conditions.

### Results and Discussion:

### Comparative Example 1

The peel adhesion of comparative example 1 was tested between glass and 2 mil (50 micrometer) thick 3SAB Mitsubishi PET film as backing, which is measured at 6.7 N/cm. The DMA of comparative example is listed in Table 1.

TABLE 1

| | G′ at -20C | G′ at 25C (MPa) | G′ at 70C (MPa) | Tan Delta at 25C | Tan Delta at 70C | Tg (°C) |
|---|---|---|---|---|---|---|
| Comparative Example 1 | 2.17E+01 | 2.03E-01 | 5.90E-02 | 0.54 | 0.31 | -3.49 |

The Td of Film 1 construction (Film 1/comparative example 1 OCA/PET) was measured. The initial Td of Film 1 film alone was measured at 4.15. After laminating the comparative example 1 OCA, and passing through the Autoclave treatment, the Td is measured at 5.22. The increase of Td with OCA lamination is indication of air pinholes have been filled. Then the sample was placed in 85C/85% relative humidity oven for a period of times, the Td of the aged samples was measured only 5% change after 360 hours aging.

### Example 1 and Comparative Example 2 OCA Performance

The peel adhesion of example 1 OCA was tested between glass and 2 mil 3SAB Mitsubishi PET film as backing, which is measured at 2.1 N/cm.

The DMA data of Example 1 OCA was listed in Table 2, wherein, two level of curing power were recorded. The 2 different levels of curing power generate Example 1 and Comparative Example 2. With higher curing power (Example 1), the OCA was fully cured with tan delta of 0.15 at 70° C., with lower UV-LED power (Comparative Example 2), the OCA was cured with slightly higher tan delta at 0.22 at 70° C.

TABLE 2

| # | UV-LED Power (J/cm2) | G′ at 25° C. G′ (mPa) | at 70° C. Tan (mPa) | Delta 25° C. | at Tan Delta at 70° C. | Tg (°C) |
|---|---|---|---|---|---|---|
| Example 1 | 2.25 | 3.57E-01 | 1.38E-01 | 0.49 | 0.15 | -6.28 |
| Comparative Example 2 | 0.815 | 4.44E-01 | 1.04E-01 | 0.53 | 0.22 | -5.11 |

The initial Td of Film 1 film alone is measured at 3.74. After laminating the comparative example 1 OCA, and passing through the Autoclave treatment, the Td is measured at 3.76. The initial Td with and without OCA lamination is similar which is indication of air pinholes have not been filled. For comparable example 2, the Td after OCA lamination was tested at 4.05, which showed some increase of transmission, which may indicate partially filled air pinholes. Then the sample was placed in 85C/85% relative humidity oven for a period of times, the Td of the aged samples was measured as below in Table 3: As shown in table 3, the Td of comparative example 2, which has high tan delta at 0.22 at 70° C., the Td showed significantly increase with aging at high temp/high humidity aging condition, indicating continued pinhole filling. However, with lower tan delta of Example 1, the Td does not show significant increases with such aging condition, indicating the air pinholes were not filled.

TABLE 3

| Film construction: Film 1/OCA/PET | Aging condition | Time (hours) | | | |
|---|---|---|---|---|---|
| | | Initial | 120h | 240h | 360h |
| Example 1 OCA | 25C | 3.74 | 3.75 | 3.74 | 3.71 |
| Example 1 OCA | 85° C./85 %RH | 3.76 | 2.76 | 3.67 | 4.1 |
| Comparable example 2 OCA | 25C | 4.05 | 4.05 | 4.02 | 4.00 |
| Comparable Example 2 OCA | 85° C./85 %RH | 4.05 | 5.0 | 4.96 | 4.91 |

### SEM Evidence:

Film construction samples were analyzed by SEM as described above. This method revealed voided laser pinholes through the ink layer, as designed, as well as a small protrusion of the void into the adjacent OCA layer (as shown as element 31, in FIG. 1), without any of the holes examined showing OCA intrusion

What is claimed is:

1. A curable adhesive composition comprising:
a curable (meth)acrylate copolymer having a weight average molecular weight in a range of 100,000 to 400,000 Da;
an optional photoinitiator; and
a co-curable additive mixture, the additive mixture comprising:
at least one epoxy (meth)acrylate oligomer;
at least one amine-functional (meth)acrylate; and
at least one urethane (meth)acrylate oligomer, and
wherein the curable (meth)acrylate copolymer comprises:
a) a first monomeric unit of Formula (I) in an amount in a range of 50 to 94 weight percent based on a total weight of monomeric units in the curable (meth)acrylate copolymer 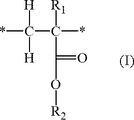
wherein
R₁ is hydrogen or methyl; and
R₂ is an alkyl, heteroalkyl, aryl, aralkyl, or alkaryl group;
b) a second monomeric unit of Formula (II) in an amount in a range of 6 to 10 weight percent based on the total weight of monomeric units in the curable (meth)acrylate copolymer 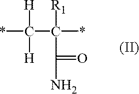
c) a third monomeric unit of Formula (III) in an amount in a range of 0.05 to 5 weight percent based on the total weight of monomeric units of the curable (meth)acrylate copolymer 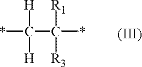
wherein
R₃ comprises 1) an aromatic ketone group that causes hydrogen abstraction from a polymeric chain when exposed to ultraviolet radiation or 2) a (meth)acryloyl group that undergoes free radical polymerization in the presence of the photoinitiator when exposed to ultraviolet or visible light radiation; and
d) an optional fourth monomeric unit of Formula (IV) in an amount in a range of 0 to 20 weight percent based on the total weight of monomeric units of the curable (meth)acrylate copolymer 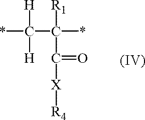
wherein 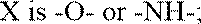
R₄ is a hydroxy-substituted alky or hydroxy-substituted heteroalkyl group; and wherein upon curing to form a cured adhesive composition, the cured adhesive composition has a shear storage modulus (G′) of greater than 90 kiloPascals (kPa) when measured at 70° C. and at a frequency of 1 radian/second; and
a Tan Delta of 0.2 or less at 70° C. where Tan Delta is the calculated ratio (G″/G′) of the measured shear storage modulus (G′) and shear loss modulus (G″).

2. The curable adhesive composition of claim 1, wherein the composition comprises 80-95% by weight of the curable (meth)acrylate copolymer and 5-20 % by weight the co-curable additive mixture, wherein the % by weight is based upon the total dry weight of the curable components.

3. The curable adhesive composition of claim 1, wherein the epoxy (meth)acrylate oligomer comprises a material of general Formula V: 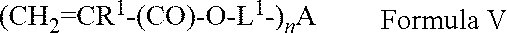
wherein R¹ is H or methyl;
(CO) is a carbonyl group;
n is an integer of 1 or 2;
L¹ is a divalent linking group comprising a hydroxyl-functional alkylene group; and
A is an n-valent group containing alkyl, alkylene, aryl, arylene, aralkyl, and aralkylene groups, and may contain one or more heteroatoms.

4. The curable adhesive composition of claim 3, wherein the group L¹ is a bisphenol A group.

5. The curable adhesive composition of claim 1, wherein the amine-functional (meth)acrylate comprises DMAPMA (N-[3-(Dimethylamino)propyl]methacrylamide).

6. The curable adhesive composition of claim 1, wherein urethane (meth)acrylate oligomer comprises a material of general Formula VI: 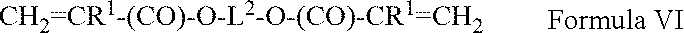
wherein R¹ is H or methyl;
(CO) is a carbonyl group;
L² is divalent linking group comprising at least one urethane linkage and further comprise alkylene groups, arylene groups, aralkylene groups, heteroalkylene groups, polyester groups, or a combination thereof.

7. The curable adhesive composition of claim 6, wherein the group L² comprises polyester segments linked by urethane groups.

8. The curable adhesive composition of claim 1, wherein the cured adhesive composition is optically clear.

9. The curable adhesive composition of claim 1, wherein the curable (meth)acrylate copolymer comprises:
a) monomer units of Formula (I) comprising a mixture of alkyl (meth)acrylates with alkyl groups having 8 or fewer carbon atoms:
b) monomer units of Formula (II) comprising (meth)acrylamide;
c) monomer units of Formula (III) formed by polymerizing a hydroxyl-functional (meth)acrylate into the (meth)acrylate matrix and subsequently reacting with an isocyanate-functional (meth)acrylate to form the units of Formula (III); and
an acid-functional (meth)acrylate.

10. The curable adhesive composition of claim 1, wherein upon curing the Tg is -6° C. or less.

11. An article comprising:
a substrate with a first major surface and a second major surface; and
a cured adhesive composition disposed on at least a portion of the second major surface of the substrate, wherein the cured adhesive composition has a shear storage modulus (G′) of greater than 90 kiloPascals (kPa) when measured at 705° C. and at a frequency of 1 radian/second;
a Tan Delta of 0.2 or less at 70° C. where Tan Delta is the calculated ratio (G″/G′) of the measured shear storage modulus (G′) and shear loss modulus (G″); and wherein the cured adhesive composition is formed by curing a curable adhesive composition, wherein the curable adhesive composition comprises:
a curable (meth)acrylate copolymer having a weight average molecular weight in a range
of 100,000 to 400,000 Da;
an optional photoinitiator; and
a co-curable additive mixture, the additive mixture comprising:
at least one epoxy (meth)acrylate oligomer;
at least one amine-functional (meth)acrylate; and
at least one urethane (meth)acrylate oligomer, and
wherein the curable (meth)acrylate copolymer comprises:
a) a first monomeric unit of Formula (I) in an amount in a range of 50 to 94 weight percent based on a total weight of monomeric units in the curable (meth)acrylate copolymer 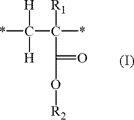
wherein
R₁ is hydrogen or methyl; and
R₂ is an alkyl, heteroalkyl, aryl, aralkyl, or alkaryl group;
b) a second monomeric unit of Formula (II) in an amount in a range of 6 to 10 weight percent based on the total weight of monomeric units in the curable (meth)acrylate copolymer 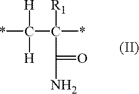
c) a third monomeric unit of Formula (III) in an amount in a range of 0.05 to 5 weight percent based on the total weight of monomeric units of the curable (meth)acrylate copolymer 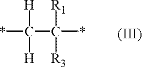
wherein
R₃ comprises 1) an aromatic ketone group that causes hydrogen abstraction from a polymeric chain when exposed to ultraviolet radiation or 2) a (meth)acryloyl group that undergoes free radical polymerization in the presence of the photoinitiator when exposed to ultraviolet or visible light radiation; and
d) an optional fourth monomeric unit of Formula (IV) in an amount in a range of 0 to 20 weight percent based on the total weight of monomeric units of the curable (meth)acrylate copolymer 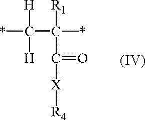
wherein 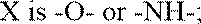
R₄ is a hydroxy-substituted alky or hydroxy-substituted heteroalkyl group.

12. The article of claim 11, wherein the second major surface of the substrate comprises a plurality of openings, wherein the openings comprise holes through the substrate or cavities within the substrate, and wherein the cured adhesive composition covering the openings does not flow into the opening.

13. The article of claim 12, wherein the adhesive composition covering the openings provides an elevated feature, wherein the elevated feature is raised above the plane of the second manor surface of the substrate.

14. The article of claim 11, wherein the curable adhesive composition comprises 80-95% by weight of the curable (meth)acrylate copolymer and 5-20 % by weight the co-curable additive mixture, wherein the % by weight is based upon the total dry weight of the curable components.

15. The article of claim 11, wherein the epoxy (meth)acrylate oligomer of the curable adhesive composition comprises a material of general Formula V: 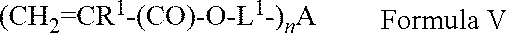
wherein R¹ is H or methyl;
(CO) is a carbonyl group;
n is an integer of 1 or 2;
L¹ is a divalent linking group comprising a hydroxyl-functional alkylene group; and
A is an n-valent group containing alkyl, alkylene, aryl, arylene, aralkyl, and aralkylene groups, and may contain one or more heteroatoms.

16. The article of claim 11, wherein the amine-functional (meth)acrylate of the curable adhesive composition comprises DMAPMA (N-[3-(Dimethylamino)propyl]methacrylamide).

17. The article of claim 11, wherein the urethane (meth)acrylate oligomer of the curable adhesive composition comprises a material of general Formula VI: 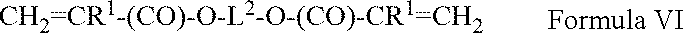
wherein R¹ is H or methyl;
(CO) is a carbonyl group;
L² is divalent linking group comprising at least one urethane linkage and further comprise alkylene groups, arylene groups, aralkylene groups, heteroalkylene groups, polyester groups, or a combination thereof.

18. The article of claim 11, wherein the cured adhesive is optically clear.

19. The article of claim 11, wherein the curable (meth)acrylate copolymer comprises:
a) monomer units of Formula (I) comprising a mixture of alkyl (meth)acrylates with alkyl groups having 8 or fewer carbon atoms:
b) monomer units of Formula (II) comprising (meth)acrylamide;
c) monomer units of Formula (III) formed by polymerizing a hydroxyl-functional (meth)acrylate into the (meth)acrylate matrix and subsequently reacting with an isocyanate-functional (meth)acrylate to form the units of Formula (III); and an acid-functional (meth)acrylate.

20. The article of claim 11, wherein the cured adhesive has a Tg of -6° C. or less.
